(19) United States
(12) Patent Application Publication
(10) Pub. No.: US 2026/0330672 A1
(43) Pub. Date: Oct. 22, 2026

(54) POSITION SPECIFYING METHOD, PROGRAM, AND DEVICE

(71) Applicant: Fujitsu Limited, Kawasaki-shi, Kanagawa (JP)

(72) Inventor: Fan YANG, Edogawa (JP)

(73) Assignee: Fujitsu Limited, Kawasaki-shi, Kanagawa (JP)

(21) Appl. No.: 19/239,737

(22) Filed: Jun. 16, 2025

Related U.S. Application Data
(63) Continuation of application No. PCT/JP2022/047480, filed on Dec. 22, 2022.

(51) Int. Cl. G06T 7/70; G06V 10/762

(52) U.S. Cl. CPC G06T 7/70; G06V 10/762

(57) ABSTRACT

The position specifying device includes a processor configured to determine whether or not a detection result of a two-dimensional position of an object in each of images captured by each of a plurality of cameras that capture the object from a different viewpoints satisfies a predetermined condition; when the detection result satisfies the condition, specifying a three-dimensional position of the object based on the detection result of the two-dimensional position and camera parameters of the cameras that capture the images in which the two-dimensional position is detected, and, when the detection result does not satisfy the condition, specifying the three-dimensional position of the object based on the detection result of the two-dimensional position, the camera parameters of the cameras that capture the images in which the two-dimensional position is detected, and a plane in a three-dimensional space determined in advance as a region where the object is present.

### CROSS-REFERENCE TO RELATED APPLICATION

This application is a continuation application of International Application No. PCT/JP2022/047480, filed Dec. 22, 2022, the disclosure of which is incorporated herein by reference in its entirely.

### FIELD

The embodiments discussed herein are related to a position specifying method, a position specifying program, and a position specifying device.

### BACKGROUND

Conventionally, a three-dimensional position of an object in a world coordinate system is calculated from a two-dimensional position of the object on a multi-viewpoint image obtained by capturing the object from a plurality of different viewpoints by using triangulation.

For example, a video analysis device that performs tracking on an object to be tracked included in video data of a plurality of viewpoints and measures an object position at each time has been proposed. In a case in which a data loss due to occlusion occurs at the measured object position at each time, the device interpolates the tracking data by estimation by solving a motion equation of the object, estimation using audio data, or a combination thereof. [Related Non-Patent Documents] Japanese Patent Application Laid-Open (JP-A) No. 2019-175115

### SUMMARY

According to an aspect of the embodiments, a position specifying method, comprising: by a processor, determining whether or not a detection result of a two-dimensional position of an object in each of images captured by each of a plurality of cameras that capture the object from a plurality of different viewpoints satisfies a predetermined condition; and in a case in which the detection result satisfies the condition, specifying a three-dimensional position of the object based on the detection result of the two-dimensional position and camera parameters of the cameras that capture the images in which the two-dimensional position is detected, and, in a case in which the detection result does not satisfy the condition, specifying the three-dimensional position of the object based on the detection result of the two-dimensional position, the camera parameters of the cameras that capture the images in which the two-dimensional position is detected, and a plane in a three-dimensional space determined in advance as a region where the object is present.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view illustrating connection between a position specifying device and a camera according to the present embodiment.

FIG. 2 is a functional block diagram of the position specifying device according to the present embodiment.

FIG. 3 is a diagram for explaining an example of a two-dimensional position of an object.

FIG. 4 is a diagram illustrating an example of a multi-viewpoint image.

FIG. 5 is a diagram illustrating an example of arrangement of cameras that capture multi-viewpoint images.

FIG. 6 is a diagram for explaining a plane used for specifying a three-dimensional position.

FIG. 7 is a diagram for explaining a case in which specification of the three-dimensional position by triangulation fails.

FIG. 8 is a diagram for explaining specification of the three-dimensional position using a plane.

FIG. 9 is a diagram for explaining specification of the three-dimensional position from tracklets of a two-dimensional position.

FIG. 10 is a diagram for explaining clustering of the tracklets.

FIG. 11 is a diagram for explaining specification of the three-dimensional position using a plane.

FIG. 12 is a diagram for explaining a case in which an object is deviated from the plane.

FIG. 13 is a block diagram illustrating a schematic configuration of a computer functioning as the position specifying device.

FIG. 14 is a flowchart illustrating an example of a position specifying process.

FIG. 15 is a schematic view illustrating an example of specifying the three-dimensional position by the triangulation.

FIG. 16 is a schematic view illustrating an example of specifying the three-dimensional position using the plane.

FIG. 17 is a schematic view illustrating an example of specifying the three-dimensional position by Comparison Method 1.

FIG. 18 is a schematic view illustrating an example of specifying the three-dimensional position by Comparison Method 2.

FIG. 19 is a schematic view illustrating an example of specifying the three-dimensional position by a method of the present embodiment.

FIG. 20 is a diagram for explaining application of the position specifying device according to the present embodiment to a scoring system of a gymnastics competition.

### DESCRIPTION OF EMBODIMENTS

Hereinafter, an example of an embodiment according to the disclosed technology will be described with reference to the drawings.

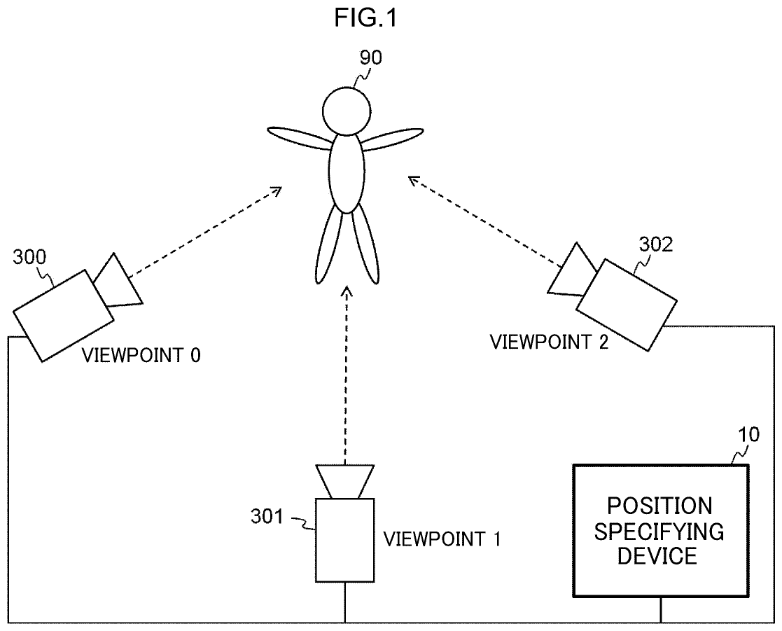

As illustrated in FIG. 1, a position specifying device 10 according to the present embodiment is connected to each of a plurality of cameras 30n that capture an object (in the example of FIG. 1, the object is a person) 90 at viewpoints n from different directions. In the example of FIG. 1, n=0, 1, and 2, and a camera 300 that performs capturing from viewpoint 0, a camera 301 that performs capturing from viewpoint 1, and a camera 302 that performs capturing from viewpoint 2 are connected to the position specifying device 10. The number of cameras 30n connected to the position specifying device 10 is not limited to the example of FIG. 1, and may be two or four or more.

The camera 30n is installed at an angle and at a position where the object 90 falls within an image capturing range. Videos captured by the camera 30n are sequentially input to the position specifying device 10. A synchronization signal is sent to each camera 30n, and the videos captured by the camera 30n are synchronized.

Here, two general methods and problems for specifying a three-dimensional position of the object 90 from a plurality of images (hereinafter, referred to as “multi-viewpoint images”) captured from a plurality of different viewpoints will be described.

As a first method, there is a method for specifying a three-dimensional position of an object on a ground plane by projecting a two-dimensional position of a foot of the object on a multi-viewpoint image on the ground plane. In this method, in a case in which a foot position of the object does not come into contact with the ground, the three-dimensional position cannot be appropriately specified.

As a second method, there is a method for specifying a three-dimensional position from a two-dimensional position of the object on the multi-viewpoint image by triangulation. In order to specify an accurate three-dimensional position in this method, the plurality of cameras that capture the multi-viewpoint images may be arranged to capture the object at various angles, and the two-dimensional position of the object may be detected from more images. In a case in which the number of images in which the two-dimensional position of the object is detected is two or less and a central angle of a vector from the camera that has captured these images to the object exceeds a predetermined range, an error is likely to occur in the specification of the three-dimensional position by triangulation, and an appropriate three-dimensional position cannot be specified.

Therefore, in the present embodiment, in a case in which the three-dimensional position of the object 90 cannot be appropriately specified by using the triangulation, the three-dimensional position of the object 90 is specified by using a plane in a three-dimensional space determined in advance as a region where the object 90 is present. Hereinafter, the position specifying device 10 will be described in detail.

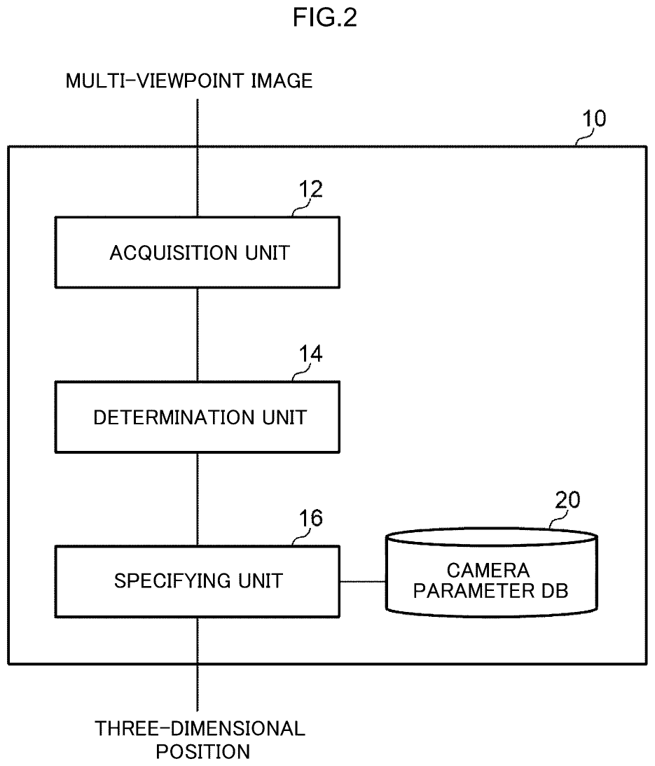

As illustrated in FIG. 2, the position specifying device 10 according to the present embodiment functionally includes an acquisition unit 12, a determination unit 14, and a specifying unit 16. A camera parameter database (DB) 20 is stored in a predetermined storage region of the position specifying device 10. The camera parameter DB 20 stores internal parameters and external parameters of each camera 30n.

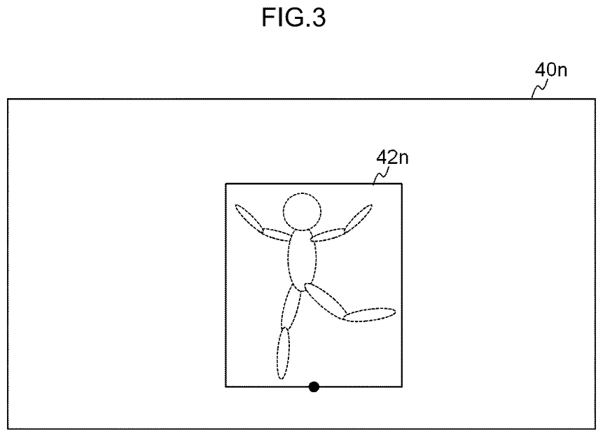

The acquisition unit 12 acquires time-series multi-viewpoint images captured by the plurality of cameras 30n. Each image 40n included in the multi-viewpoint image is given information on the two-dimensional position of the object 90. The information on the two-dimensional position of the object 90 may be a coordinate value of a predetermined point in a region surrounding the object 90 detected from each image 40n included in the multi-viewpoint image by using a detection model generated in advance by machine learning in order to detect the region of the object 90 from the image 40n. For example, as illustrated in FIG. 3, in a case in which the region of the object 90 is detected by a two-dimensional bounding box (hereinafter, referred to as “2D-BBOX”) 42n, coordinates of a predetermined position of the 2D-BBOX 42n may be used as the information on the two-dimensional position of the object 90. The predetermined position may be, for example, a center of the 2D-BBOX 42n, a midpoint of a bottom side, or a point of any corner (for example, an upper left corner). In the example of FIG. 3, an example in which a midpoint (black circle in FIG. 3) of the bottom side of the 2D-BBOX 42n is set as the two-dimensional position of the object 90 is illustrated.

In a case in which the multi-viewpoint image to which the information on the two-dimensional position of the object 90 is not given is acquired, the acquisition unit 12 may acquire the information on the two-dimensional position of the object 90 by using the detection model.

The determination unit 14 determines whether or not a detection result of the two-dimensional position of the object 90 on the multi-viewpoint image acquired by the acquisition unit 12 satisfies a predetermined condition as a condition for specifying the three-dimensional position by triangulation.

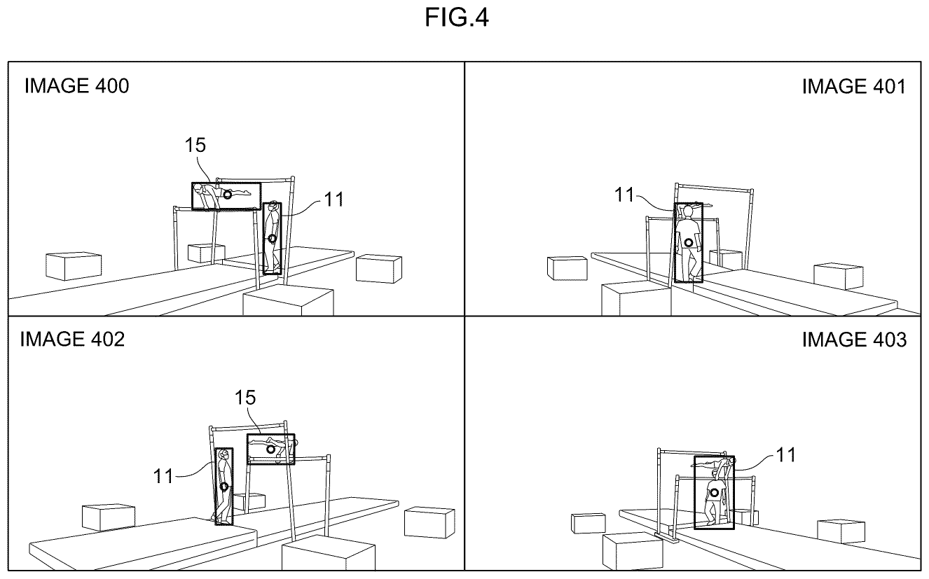

Here, for example, as illustrated in FIG. 4, in images 400, 401, 402, and 403 which are multi-viewpoint images at a certain time, 2D-BBOXs 42n for two objects 90 identified by numbers 11 and 15 are detected. The object 90 with number 15 is a gymnast performing performance of uneven bars, and the object 90 having number 11 is an assistant who assists a target player. In the example of FIG. 4, the two-dimensional position is not detected from the images 401 and 403 for the object 90 having number 15. In this case, the three-dimensional position is specified based on the two-dimensional position detected from the images 400 and 402.

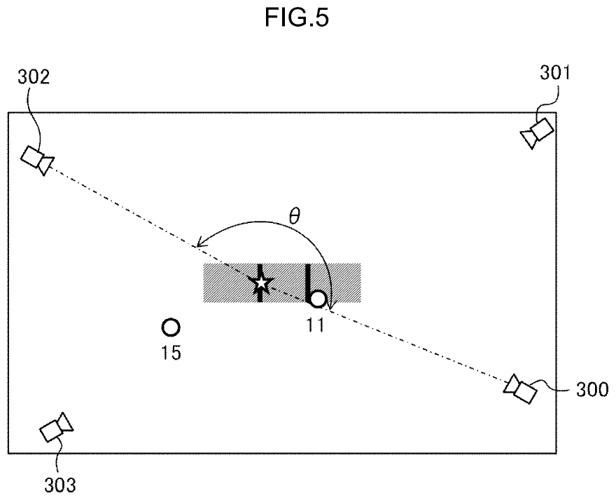

FIG. 5 illustrates the arrangement of the cameras 300, 301, 302, and 303 that have captured the multi-viewpoint images. FIG. 5 is a schematic plan view of a range including a competition area (hatched portion in FIG. 5) of the uneven bars and the camera 30n as viewed from above. A thick solid line in the competition area indicates a position of the uneven bars. As illustrated in FIG. 5, a central angle (θ in FIG. 5) between a vector from the camera 300 that has captured the image 400 to the position of the object 90 (star mark in FIG. 5) and a vector from the camera 302 that has captured the image 402 to the position of the object 90 exceeds a predetermined range. The predetermined range is a range excluding an angle close to 0° or 180°, and may be, for example, 20° to 160°. As described above, in a case in which the arrangement of two cameras exceeds the predetermined range and in a case in which the three-dimensional position is specified by triangulation from the images 400 and 402, a position deviated from an actual position of the object 90 may be specified as indicated by a circle mark having number 15 in FIG. 5.

Therefore, the above-described condition for specifying the three-dimensional position by triangulation may be that there are three or more images 40n in which the two-dimensional position of the same object 90 is detected on the multi-viewpoint images captured at the same time. In a case in which the cameras 30n are arranged so as to be uniformly positioned with respect to the object 90 and in a case in which there are three cameras 30n, the central angle is approximately 120°, and falls within the predetermined range. The condition may be that, on the multi-viewpoint images captured at the same time, there are two or more images in which the two-dimensional position of the same object 90 is detected, and the central angle of the vector from the camera 30n to the object 90 is within a predetermined range.

Which condition is adopted may be determined based on the arrangement of the cameras 30n, a movement range of the object 90, and the like. For example, in a case in which the arrangement of the cameras 30n is not uniform, the latter condition may be adopted. For example, in a case in which a movement range of the gymnast who is the object 90 is large as in a case in which a performance type is a balance beam, since a processing load of calculating the central angle for each image increases, the former condition may be adopted to avoid this increase in processing load.

In a case in which it is determined that the detection result of the two-dimensional position satisfies the condition, the specifying unit 16 specifies the three-dimensional position of the object 90 by triangulation. Specifically, the specifying unit 16 acquires, from the camera parameter DB 20, camera parameters of the camera 30n that has captured the image 40n in which the two-dimensional position of the object 90 is detected on the multi-viewpoint image. The specifying unit 16 specifies the three-dimensional position of the object 90 based on the two-dimensional position of the object 90 on each image 40n and the acquired camera parameters.

In a case in which it is determined that the detection result of the two-dimensional position does not satisfy the condition, the specifying unit 16 specifies the three-dimensional position of the object 90 by using the plane in the three-dimensional space determined in advance as the region where the object 90 is present. For example, this plane may be a vertical plane along a direction in which the object 90 moves. More specifically, this plane is a plane in which X=0 in a case in which the direction in which the object 90 moves on a horizontal plane is a Y axis, a direction orthogonal to the Y axis on the horizontal plane is an X axis, and a normal direction of the horizontal plane is a Z axis. That is, this plane is a plane whose normal vector is [1, 0, 0].

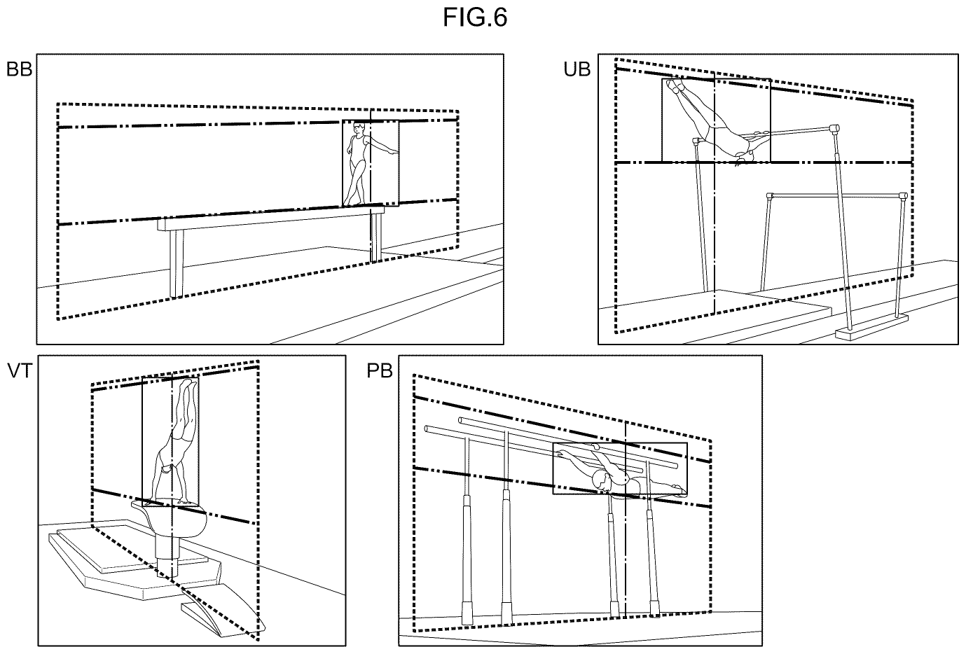

For example, in a case in which the object 90 is a gymnast, as illustrated in FIG. 6, since the gymnast who is performing moves in a predetermined direction based on an apparatus used in each event, a vertical plane along the predetermined direction is determined in advance as the plane. In the example of FIG. 6, an upper left diagram is a case in which the event is a balance beam (BB), an upper right diagram is a case in which the event is an uneven bar (UB), a lower left diagram is a case in which the event is a vault (VT), and a lower right diagram is a case in which the event is a parallel bar (PB). In FIG. 6, a dotted line represents a part of a predetermined plane with the apparatus as a reference. There is a high possibility that the gymnast who is performing that is the object 90 moves in this plane. That is, on the image 40n, midpoints of an upper side and a lower side of the 2D-BBOX 42n are often within this plane as indicated by a one-dot chain line and a two-dot chain line in FIG. 6.

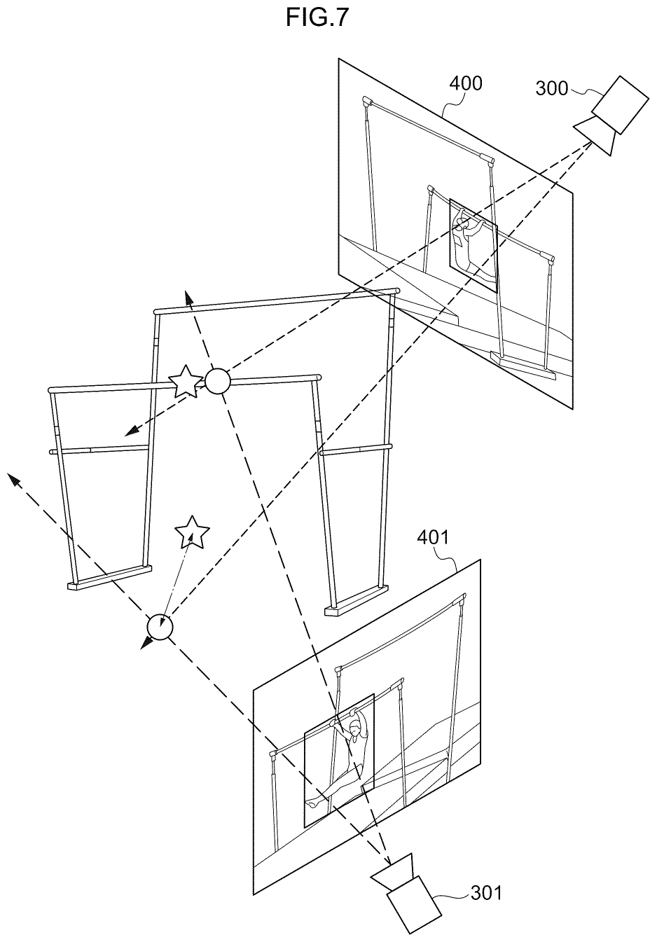

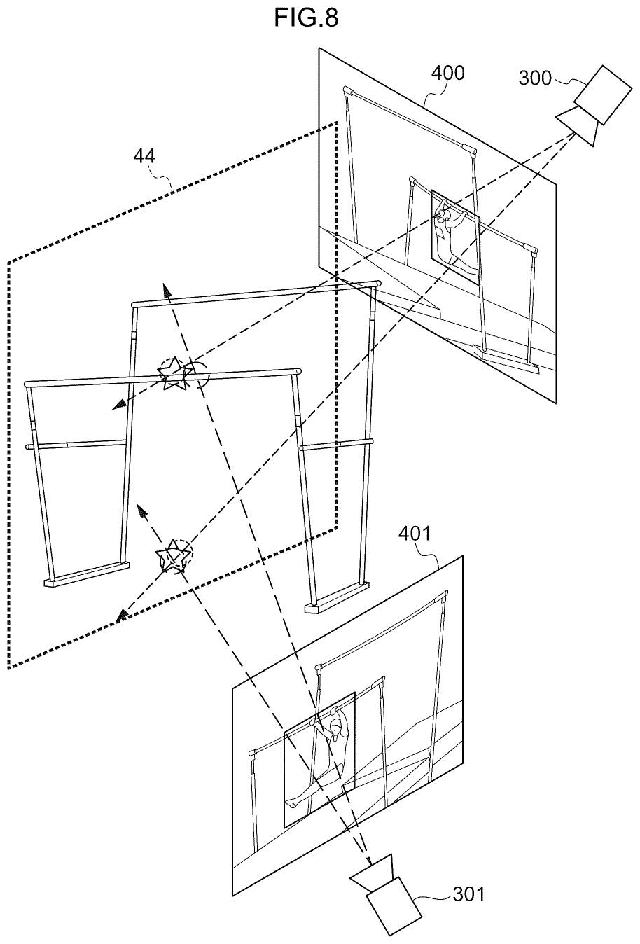

In a case in which the detection result of the two-dimensional position of the object 90 on the multi-viewpoint image does not satisfy a condition for triangulation, as illustrated in FIG. 7, an actual three-dimensional position (star mark) and the specified three-dimensional position (circle mark) may be deviated from each other. In the present embodiment, as illustrated in FIG. 8, in a case in which the detection result of the two-dimensional position does not satisfy the condition for triangulation, the specifying unit 16 specifies, as the three-dimensional position, projection points obtained by projecting the two-dimensional position on a plane 44 based on the camera parameters. That is, the specifying unit 16 specifies, as the three-dimensional position, an intersection of the plane 44 and a straight line passing through a center of the camera 30n and the two-dimensional position detected from the image 40n.

In a case in which the three-dimensional position is specified by using the plane 44, the three-dimensional position can be specified as long as the two-dimensional position is detected from at least one image 40n for one object 90 (one person). In a case in which the two-dimensional position is detected from the two images 40n for one object 90, the specifying unit 16 specifies, as the three-dimensional position, an average position of two projection points in a case in which a distance between projection points corresponding to the two images is equal to or less than a predetermined value. In a case in which the distance between the projection points exceeds the predetermined value, in an actual three-dimensional space, the three-dimensional position is regarded as projection points at which a two-dimensional position of a person (for example, an assistant or the like) who does not exist on the plane 44 is projected, and the three-dimensional position is not specified.

In the example of FIG. 8, in a case in which the distance between the projection point from the image 400 and the projection point from the image 401 is a predetermined value or less, the specifying unit 16 specifies, as the three-dimensional position, an average position of the projection point from the image 400 and the projection point from the image 401. For example, the specifying unit 16 clusters the projection points projected on the plane 44 based on the distance between the projection points. The specifying unit 16 specifies, as the three-dimensional position, an average position of the projection points in the cluster including the plurality of projection points. In a case in which only one projection point is included in the cluster, it is determined that the distance between the projection points exceeds the predetermined value, the projection points are excluded as an outlier, and the three-dimensional position is not specified.

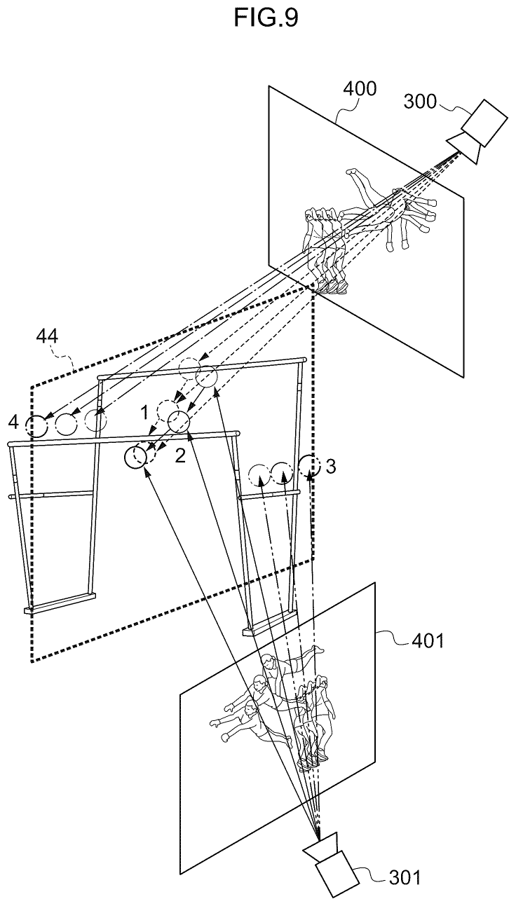

As illustrated in FIG. 9, the specifying unit 16 may specify the three-dimensional position by projecting a tracklet, which is a series of a plurality of two-dimensional positions of the same object 90 detected from a plurality of images captured at a plurality of times including the time of the processing target, onto the plane 44. In the example of FIG. 9, a series of two-dimensional positions corresponding to 3 hours is treated as one tracklet. In FIG. 9, a number written together with each tracklet is an identification number of the tracklet. The example of FIG. 9 illustrates a case in which two-dimensional positions for two persons are detected from each of the two images 400 and 401. In this case, the specifying unit 16 clusters tracklets by a distance between projection points in the tracklets, and specifies, as the three-dimensional position, an average position of the projection points in the tracklets in the cluster including the plurality of tracklets.

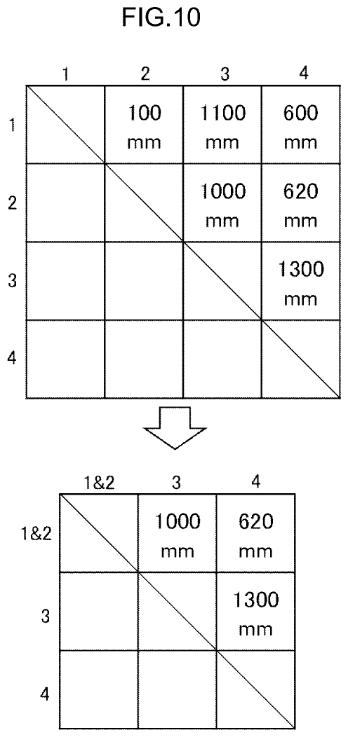

For example, as illustrated in FIG. 10, the specifying unit 16 prepares a matrix in which each tracklet is associated with each of rows and columns. In FIG. 10, numbers written in the rows and columns are identification numbers of the tracklets. The specifying unit 16 calculates a distance between a tracklet corresponding to a row corresponding to each cell of the matrix and a tracklet corresponding to a column. The distance between the tracklets may be an average of the distances between the projection points at the same time in all the tracklets. In a case in which a value of the mass is equal to or less than a threshold (for example, 500 mm), the specifying unit 16 groups tracklets corresponding to a row and a column corresponding to the mass into one cluster. In the example of FIG. 10, tracklet 1 and tracklet 2 are grouped into one cluster. The specifying unit 16 repeats the clustering of the tracklets until there is no value of the cell equal to or less than the threshold.

In this case, the specifying unit 16 determines that tracklet 1 and tracklet 2 classified into the same cluster are the tracklets for the same object 90. The specifying unit 16 specifies, as the three-dimensional position of the object 90, an average position of the projection points constituting each of tracklet 1 and tracklet 2. Tracklet 3 and tracklet 4 that are not clustered with other tracklets are regarded as tracklets of the person (for example, an assistant or the like) who does not exist on the plane 44, and the three-dimensional position is not specified.

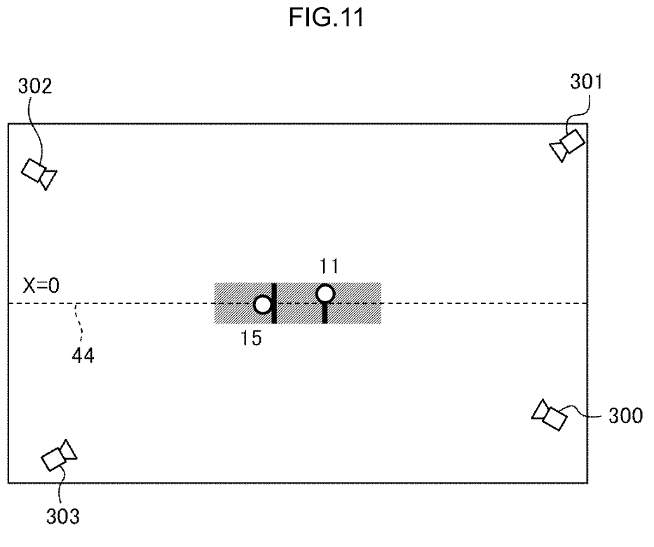

FIG. 11 schematically illustrates an example similar to FIGS. 4 and 5, that is, an example in which the three-dimensional position is specified by using the plane 44 in a case in which the two-dimensional position is detected only from the images 400 and 402 for the object 90 having number 15. As illustrated in FIG. 11, even in a case in which the central angle between the vector from the camera 300 to the object 90 and the vector from the camera 302 to the object 90 is close to 180°, the three-dimensional position of the object 90 is correctly specified to the position of the uneven bar by using the plane 44.

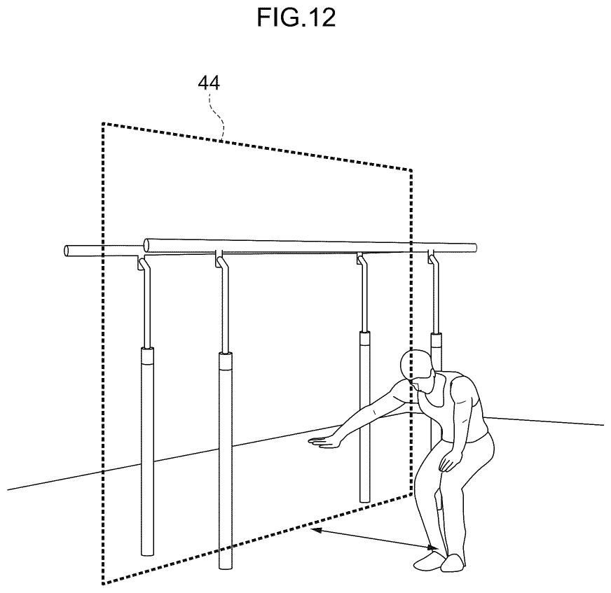

Since specification accuracy of the three-dimensional position using the plane 44 is high, it is also conceivable to execute the specification of the three-dimensional position using the plane 44 regardless of whether or not the detection result of the two-dimensional position satisfies the condition for triangulation. However, for example, in the case of the parallel bar, a vertical plane at a central position of two bars along an extending direction of the bars is set as the plane 44. As illustrated in FIG. 12, the performance is performed at a position deviated from the plane 44 from a terminal maneuver to landing. In such a case, in a case in which the plane 44 is used, an appropriate three-dimensional position cannot be specified. Therefore, in the present embodiment, as described above, in a case in which the detection result of the two-dimensional position does not satisfy the condition for triangulation, the three-dimensional position is specified by using the plane 44.

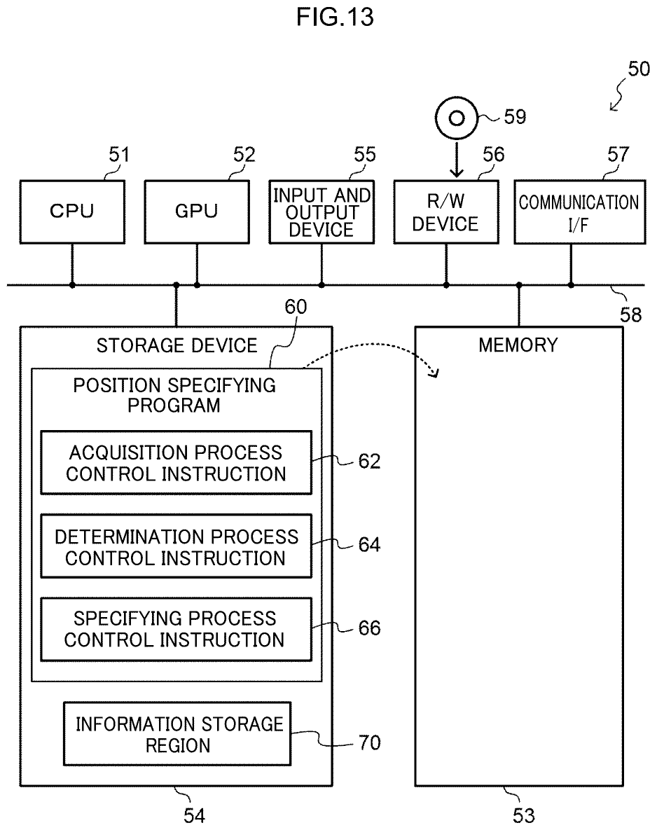

The position specifying device 10 may be realized by, for example, a computer 50 illustrated in FIG. 13. The computer 50 includes a central processing unit (CPU) 51, a graphics processing unit (GPU) 52, a memory 53 as a temporary storage region, and a non-volatile storage device 54. The computer 50 includes an input and output device 55 such as an input device and a display device, and a read/write (R/W) device 56 that controls reading and writing of data with respect to a storage medium 59. The computer 50 further includes a communication interface (I/F) 57 connected to a network such as the Internet. The CPU 51, the GPU 52, the memory 53, the storage device 54, the input and output device 55, the R/W device 56, and the communication I/F 57 are connected to each other via a bus 58.

The storage device 54 is, for example, a hard disk drive (HDD), a solid state drive (SSD), a flash memory, or the like. The storage device 54 as a storage medium stores a position specifying program 60 for causing the computer 50 to function as the position specifying device 10. The position specifying program 60 has an acquisition process control instruction 62, a determination process control instruction 64, and a specifying process control instruction 66. The storage device 54 has an information storage region 70 in which information constituting the camera parameter DB 20 is stored.

The CPU 51 reads the position specifying program 60 from the storage device 54, loads the program in the memory 53, and sequentially executes the control instructions included in the position specifying program 60. The CPU 51 operates as the acquisition unit 12 illustrated in FIG. 2 by executing the acquisition process control instruction 62. The CPU 51 operates as the determination unit 14 illustrated in FIG. 2 by executing the determination process control instruction 64. The CPU 51 operates as the specifying unit 16 illustrated in FIG. 2 by executing the specifying process control instruction 66. The CPU 51 reads information from the information storage region 70 and loads the camera parameter DB 20 in the memory 53. As a result, the computer 50 that has executed the position specifying program 60 functions as the position specifying device 10. The CPU 51 that executes the program is hardware. A part of the program may be executed by the GPU 52.

Functions realized by the position specifying program 60 may be realized by, for example, a semiconductor integrated circuit, more specifically, an application specific integrated circuit (ASIC), a field-programmable gate array (FPGA), or the like.

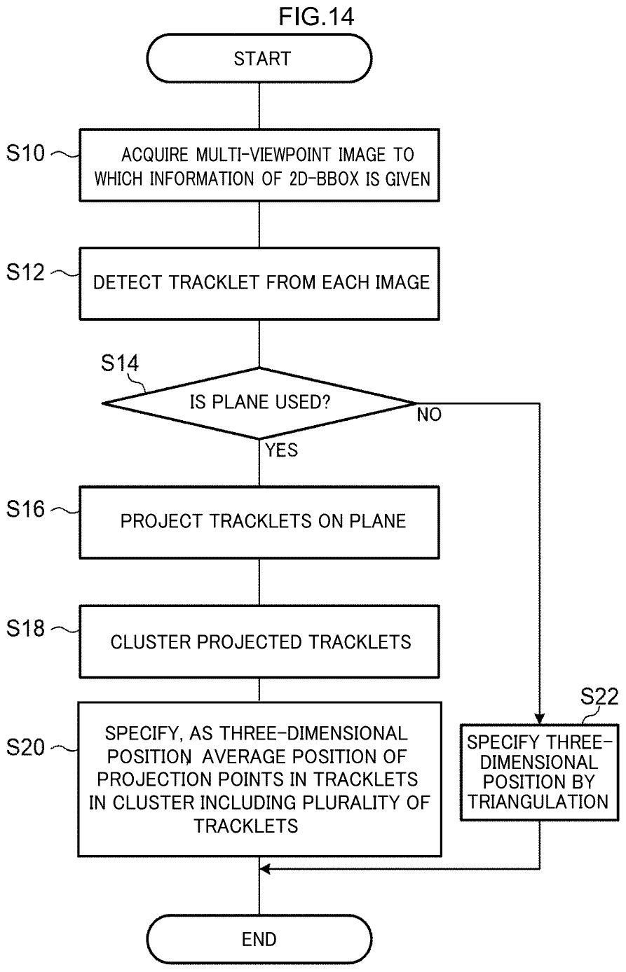

Next, an operation of the position specifying device 10 according to the present embodiment will be described. In a case in which the multi-viewpoint image is input to the position specifying device 10 and the specification of the three-dimensional position of the object 90 is instructed, the position specifying device 10 executes a position specifying process illustrated in FIG. 14. The position specifying process is an example of a position specifying method of the disclosed technology.

In step S10, the acquisition unit 12 acquires the multi-viewpoint image to which the information of the 2D-BBOX 42n indicating the region of the object 90 is given. Subsequently, in step S12, the acquisition unit 12 detects time-series tracklets of the 2D-BBOX 42n by tracking the 2D-BBOX 42n in a time direction from each image of multi-viewpoint images for a plurality of times.

Subsequently, in step S14, the determination unit 14 determines whether to specify the three-dimensional position by using the plane 44 or to specify the three-dimensional position by triangulation. In a case in which the detection result of the two-dimensional position of the object 90 on the multi-viewpoint image does not satisfy a predetermined condition as the condition for specifying the three-dimensional position by triangulation, the determination unit 14 determines to use the plane 44, and the processing proceeds to step S16. In a case in which the detection result of the two-dimensional position satisfies the condition, it is determined to specify the three-dimensional position by triangulation, and the processing proceeds to step S22.

In step S16, the specifying unit 16 projects the tracklet detected from each image 40n onto the plane 44 in the three-dimensional space determined in advance as the region where the object 90 is present. Subsequently, in step S18, the specifying unit 16 clusters the tracklets based on the distance between the tracklets. Subsequently, in step S20, the average position of the projection points in the tracklets in the cluster including the plurality of tracklets is specified as the three-dimensional position, information of the specified three-dimensional position is output, and the position specifying process ends.

In step S22, the specifying unit 16 specifies the three-dimensional position of the object 90 by triangulation and outputs information of the specified three-dimensional position, and the position specification process ends.

As described above, the position specifying device according to the present embodiment determines whether or not the detection result of the two-dimensional position of the object on the multi-viewpoint image satisfies the predetermined condition as the condition for specifying the three-dimensional position by triangulation. In a case in which the detection result satisfies the condition, the position specifying device specifies the three-dimensional position of the object by triangulation based on the detection result of the two-dimensional position and the camera parameters of the camera that has captured the image. In a case in which the detection result does not satisfy the condition, the position specifying device specifies the three-dimensional position of the object based on the plane in the three-dimensional space determined in advance as the region where the object is present. As a result, it is possible to improve robustness of the three-dimensional position specification of the object using the multi-viewpoint images.

In the above embodiment, although it has been described that the plane in which the presence of the object is assumed is the vertical plane, the disclosed technology is not limited thereto. A horizontal plane may be set or a plane having an inclination may be set depending on the range in which the object moves.

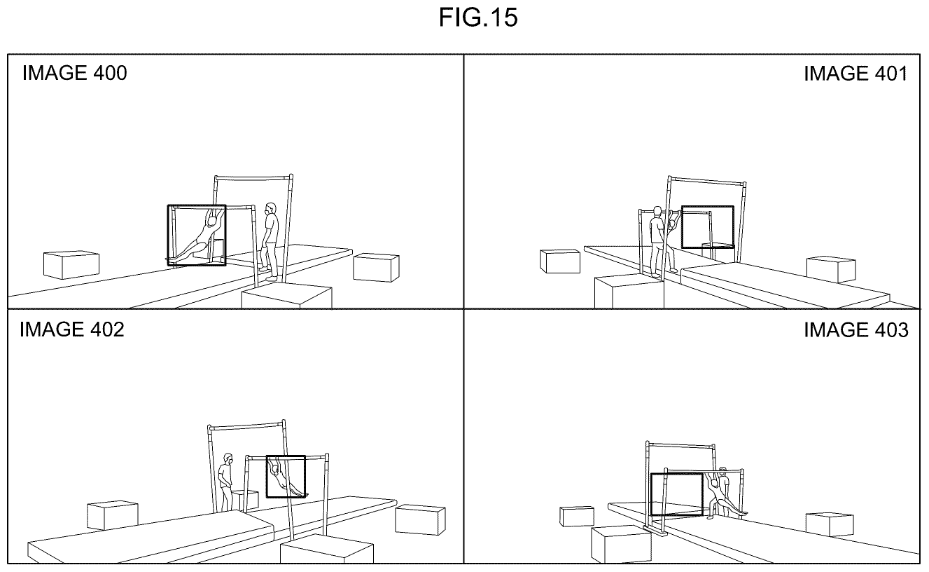

Here, FIG. 15 schematically illustrates an example in which the three-dimensional position specified by triangulation is reprojected on the multi-viewpoint image. The example of FIG. 15 is a case in which the detection result of the two-dimensional position from the multi-viewpoint image does not satisfy the condition for specifying the three-dimensional position by triangulation described in the above embodiment. In this case, there is a possibility that the three-dimensional position specified by triangulation is inaccurate, and in a case in which the specified three-dimensional position is inaccurate, the two-dimensional position to be reprojected is also inaccurate. As illustrated in FIG. 15, on the images 401 and 403, the reprojected two-dimensional position is deviated from a position of the gymnast that is the object, and is inaccurate.

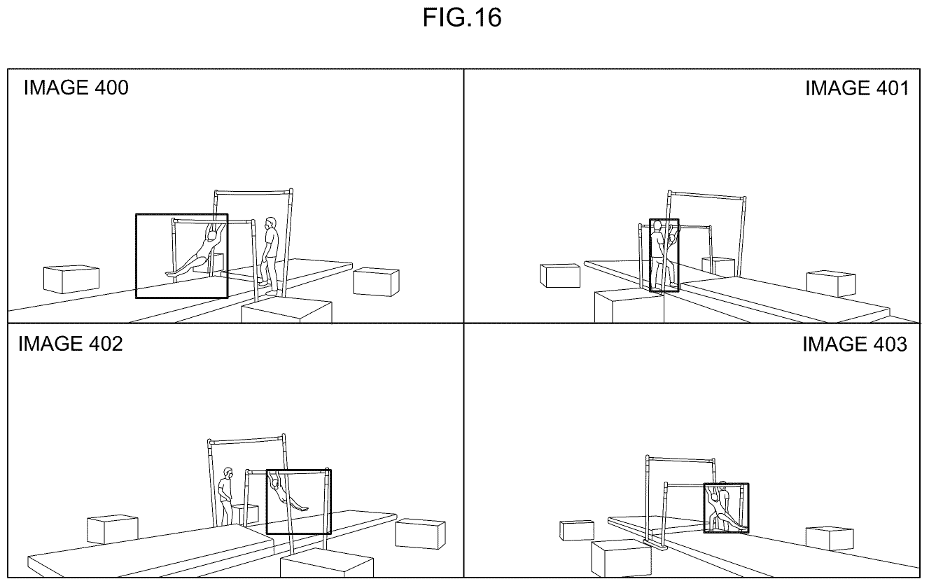

FIG. 16 schematically illustrates an example in which a three-dimensional position is specified by using a plane from a multi-viewpoint image similar to that in FIG. 15, and the specified three-dimensional position is reprojected on the multi-viewpoint image. As illustrated in FIG. 16, in a case in which an object is present on an assumed plane, even in a case in which the specification of the three-dimensional position fails by triangulation, an appropriate three-dimensional position can be specified.

In the above embodiment, the hybrid method in which the triangulation is used in a case in which the detection result of the two-dimensional position on the multi-viewpoint image satisfies the condition for specifying the three-dimensional position by triangulation and the plane is used in a case in which the detection result does not satisfy the condition has been described. The effectiveness of this hybrid method will be described in comparison with a method using only triangulation (hereinafter, referred to as “Comparative Method 1”) and a method for specifying, as a three-dimensional position, projection points obtained by projecting two-dimensional positions detected from images of two viewpoints on a plane (hereinafter, referred to as “Comparative Method 2”).

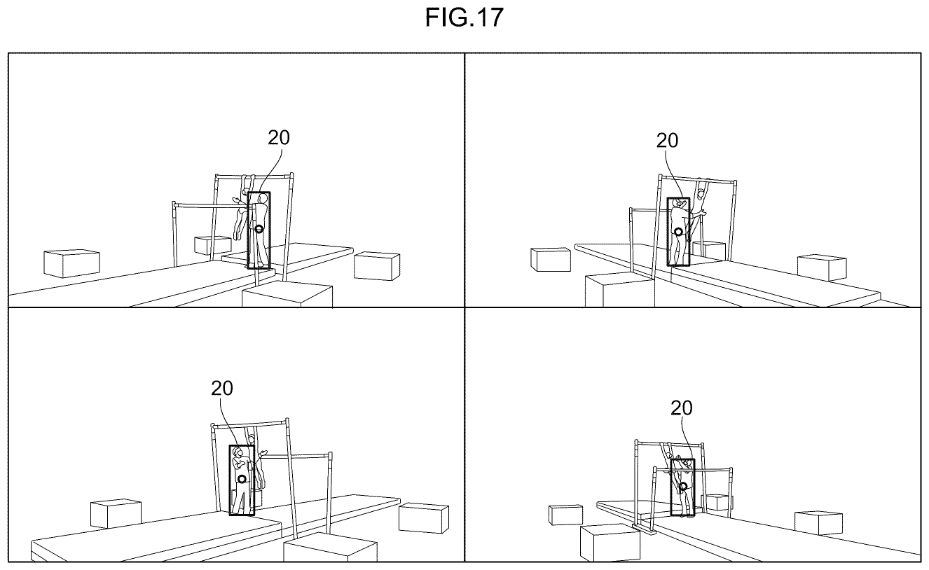

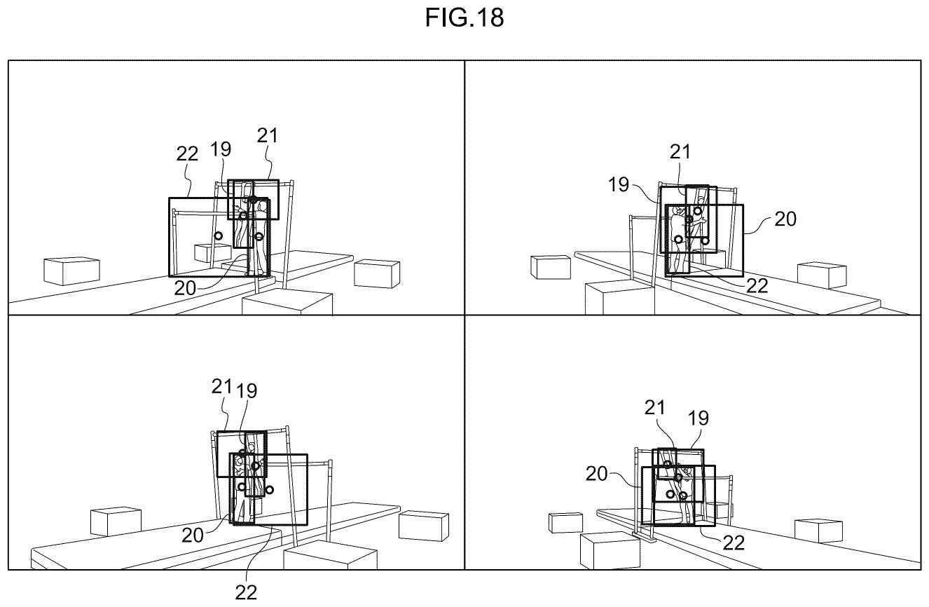

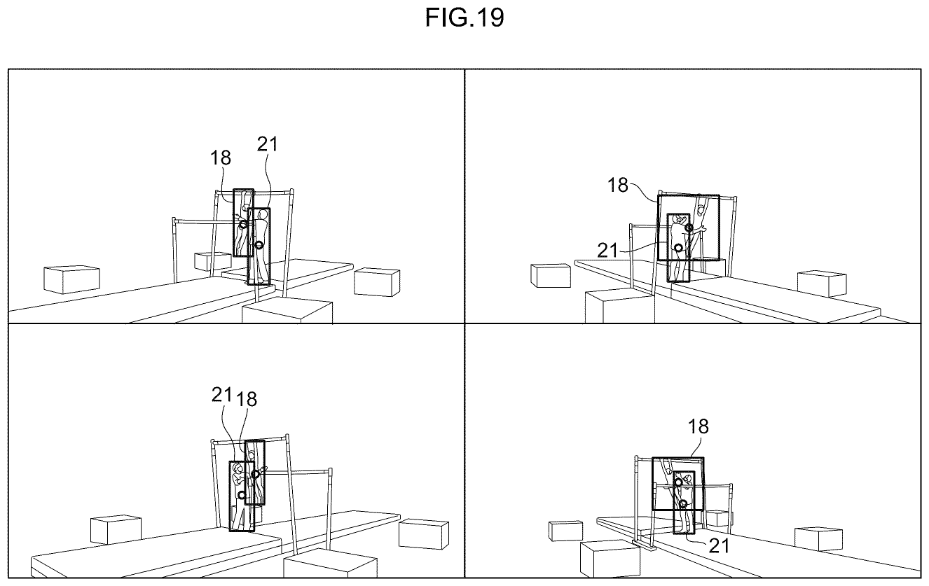

FIG. 17, FIG. 18, and FIG. 19 illustrate schematic views obtained by reprojecting, on the multi-viewpoint image, the three-dimensional positions specified by the methods in the case of Comparison Method 1, the case of Comparison Method 2, and the case of the method (hybrid method) of the present embodiment. FIGS. 17 to 19 are examples of the multi-viewpoint images in a case in which the two-dimensional position of the gymnast cannot be detected on some images by the gymnast being shielded by the assistant. As illustrated in FIG. 17, in Comparison Method 1, the triangulation fails due to a loss in the two-dimensional position, and the three-dimensional position of the gymnast is not specified. As illustrated in FIG. 18, in Comparison Method 2, a three-dimensional position of an assistant or the like that is not originally present on a plane is also specified on the plane, and erroneous detection of the object occurs. In the method of the present embodiment, the three-dimensional position of the assistant is specified by triangulation, and the three-dimensional position of the gymnast is specified by using the plane. As a result, as illustrated in FIG. 19, in the method of the present embodiment, the three-dimensional position of the gymnast is accurately specified as compared with Comparison Methods 1 and 2.

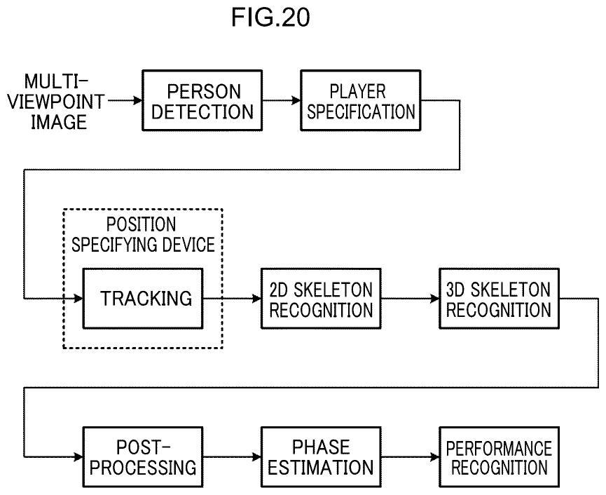

The position specifying device according to the above embodiment can be applied to, for example, a scoring system of a gymnastics competition. Here, an outline of processing of the scoring system of the gymnastics competition will be described with reference to FIG. 20.

In a case in which the multi-viewpoint image is input, the scoring system detects the region of the person from each image included in the multi-viewpoint image. Next, the scoring system determines whether the person indicated by the detected region is a player or an object other than the player based on whether a position where the person is present is in the competition area or the like, and specifies a region indicating the player. The scoring system tracks the player and associates the tracked player between a plurality of viewpoints, that is, between images by associating regions indicating the same player among a plurality of frames of a single viewpoint on the time-series multi-viewpoint images. The scoring system recognizes two-dimensional skeleton information of the player from each of the tracked series of images by using a recognition model or the like. The scoring system estimates three-dimensional skeleton information from the two-dimensional skeleton information by using the camera parameters. The scoring system performs post-processing such as smoothing on the time-series three-dimensional skeleton information, estimates a phase (break) of the performance, and then recognizes a technique. In the tracking process, the position specifying device according to the embodiment can be applied.

The disclosed technology is not limited to a case in which the object is the gymnast, and can be applied to various persons such as players in other competitions and general pedestrians as the object. It is also possible to apply an animal, a vehicle, or the like other than the person as the object.

In the above embodiment, although the position specifying program is stored (installed) in the storage device in advance, the disclosed technology is not limited thereto. The program according to the disclosed technology may be provided in a form stored in a storage medium such as a CD-ROM, a DVD-ROM, or a USB memory.

In a case in which there are two or less viewpoints from which the object is detected on the multi-viewpoint image, it may be difficult to specify the three-dimensional position from the two-dimensional position of the object on the image by applying triangulation. In the above related technology, in a case in which the object is a ball, data loss due to occlusion is interpolated by estimating a trajectory of the ball by a motion equation, and the three-dimensional position is specified. However, in a case in which the motion of the object is complicated and the trajectory is difficult to be predicted, the data loss cannot be appropriately interpolated, and the three-dimensional position cannot be specified in some cases. In the above related technology, although the interpolation of the data loss by audio data generated in a case in which the object collides is also performed, the audio data is not necessarily used for the interpolation of the data loss depending on an environment in which the object is captured.

According to the disclosed technology, it is possible to improve robustness of three-dimensional position specification of the object using the multi-viewpoint image.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A position specifying method, comprising:
by a processor,
determining whether or not a detection result of a two-dimensional position of an object in each of images captured by each of a plurality of cameras that capture the object from a plurality of different viewpoints satisfies a predetermined condition; and
in a case in which the detection result satisfies the condition, specifying a three-dimensional position of the object based on the detection result of the two-dimensional position and camera parameters of the cameras that capture the images in which the two-dimensional position is detected, and, in a case in which the detection result does not satisfy the condition, specifying the three-dimensional position of the object based on the detection result of the two-dimensional position, the camera parameters of the cameras that capture the images in which the two-dimensional position is detected, and a plane in a three-dimensional space determined in advance as a region where the object is present.

2. The position specifying method of claim 1, wherein:
the condition is a condition that is necessary to specify the three-dimensional position from the two-dimensional position by triangulation.

3. The position specifying method of claim 2, wherein:
the condition is that a number of images in which the two-dimensional position of a same object is detected is three or more, or that the number of images in which the two-dimensional position of the same object is detected is two or more and that a central angle between vectors from each of the cameras that capture the images in which the two-dimensional position of the object is detected, to the object, is within a predetermined range.

4. The position specifying method of claim 1, wherein:
specifying the three-dimensional position of the object in a case in which the detection result does not satisfy the condition includes specifying, as the three-dimensional position, projection points obtained by projecting the two-dimensional position on the plane based on the camera parameters.

5. The position specifying method of claim 4, further comprising:
specifying, as the three-dimensional position, an average position of two projection points in a case in which the two-dimensional position is detected from two images and in a case in which a distance between the projection points corresponding to the two images is a predetermined value or less.

6. The position specifying method of claim 5, further comprising:
clustering a plurality of the projection points by a distance between the projection points, and specifying, as the three-dimensional position, an average position of the projection points in a cluster including the plurality of the projection points.

7. The position specifying method of claim 6, further comprising:
clustering a series of a plurality of the two-dimensional positions detected from a plurality of images captured at a plurality of times by a distance between the projection points in the series and specifying, as the three-dimensional position, an average position between the projection points in the series in a cluster including a plurality of the series in a case in which the series for a same object is projected on the plane.

8. The position specifying method of claim 1, wherein:
the plane is a vertical plane along a direction in which the object moves.

9. A non-transitory recording medium storing a program that causes a computer to execute position specifying processing, comprising:
determining whether or not a detection result of a two-dimensional position of an object in each of images captured by each of a plurality of cameras that capture the object from a plurality of different viewpoints satisfies a predetermined condition; and
in a case in which the detection result satisfies the condition, specifying a three-dimensional position of the object based on the detection result of the two-dimensional position and camera parameters of the cameras that capture the images in which the two-dimensional position is detected, and, in a case in which the detection result does not satisfy the condition, specifying the three-dimensional position of the object based on the detection result of the two-dimensional position, the camera parameters of the cameras that capture the images in which the two-dimensional position is detected, and a plane in a three-dimensional space determined in advance as a region where the object is present.

10. The non-transitory recording medium of claim 9, wherein:
the condition is a condition that is necessary to specify the three-dimensional position from the two-dimensional position by triangulation.

11. The non-transitory recording medium of claim 10, wherein:
the condition is that a number of images in which the two-dimensional position of a same object is detected is three or more, or that the number of images in which the two-dimensional position of the same object is detected is two or more and that a central angle between vectors from each of the cameras that capture the images in which the two-dimensional position of the object is detected, to the object, is within a predetermined range.

12. The non-transitory recording medium of claim 9, wherein:
specifying the three-dimensional position of the object in a case in which the detection result does not satisfy the condition includes specifying, as the three-dimensional position, projection points obtained by projecting the two-dimensional position on the plane based on the camera parameters.

13. The non-transitory recording medium of claim 12, further comprising:
specifying, as the three-dimensional position, an average position of two projection points in a case in which the two-dimensional position is detected from two images and in a case in which a distance between the projection points corresponding to the two images is a predetermined value or less.

14. The non-transitory recording medium of claim 13, further comprising:
clustering a plurality of the projection points by a distance between the projection points, and specifying, as the three-dimensional position, an average position of the projection points in a cluster including the plurality of the projection points.

15. The non-transitory recording medium of claim 14, further comprising:
clustering a series of a plurality of the two-dimensional positions detected from a plurality of images captured at a plurality of times by a distance between the projection points in the series, and specifying, as the three-dimensional position, an average position between the projection points in the series in a cluster including a plurality of the series in a case in which the series for a same object is projected on the plane.

16. The non-transitory recording medium of claim 9, wherein:
the plane is a vertical plane along a direction in which the object moves.

17. A position specifying device, comprising:
a memory; and
a processor coupled to the memory, the processor being configured to execute processing, the processing including:
determining whether or not a detection result of a two-dimensional position of an object in each of images captured by each of a plurality of cameras that capture the object from a plurality of different viewpoints satisfies a predetermined condition; and
in a case in which the detection result satisfies the condition, specifying a three-dimensional position of the object based on the detection result of the two-dimensional position and camera parameters of the cameras that capture the images in which the two-dimensional position is detected, and, in a case in which the detection result does not satisfy the condition, specifying the three-dimensional position of the object based on the detection result of the two-dimensional position, the camera parameters of the cameras that capture the images in which the two-dimensional position is detected, and a plane in a three-dimensional space determined in advance as a region where the object is present.

18. The position specifying device of claim 17, wherein, in the processing:
the condition is a condition that is necessary to specify the three-dimensional position from the two-dimensional position by triangulation.

19. The position specifying device of claim 18, wherein, in the processing:
the condition is that a number of images in which the two-dimensional position of a same object is detected is three or more, or that the number of images in which the two-dimensional position of the same object is detected is two or more and that a central angle between vectors from each of the cameras that capture the images in which the two-dimensional position of the object is detected, to the object, is within a predetermined range.

20. The position specifying device of claim 17, wherein, in the processing:
specifying the three-dimensional position of the object in a case in which the detection result does not satisfy the condition includes specifying, as the three-dimensional position, projection points obtained by projecting the two-dimensional position on the plane based on the camera parameters.
